(19) United States
(12) Patent Application Publication
(10) Pub. No.: US 2009/0260185 A1
(43) Pub. Date: Oct. 22, 2009

(54) TAMPER RESISTANT HINGE

(75) Inventors: Patrick A. Conner, Elkhart, IN (US); Robert I. Chidister, Osceola, IN (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: IMPERIAL STAMPING CORPORATION, Elkhart, IN (US)

(21) Appl. No.: 12/425,807

(22) Filed: Apr. 17, 2009

Related U.S. Application Data
(60) Provisional application No. 61/046,997, filed on Apr. 22, 2008.

(51) Int. Cl. E05D 11/00

(52) U.S. Cl. 16/251

(57) ABSTRACT

A hinge assembly incorporates an anti-tamper member that is selectively positionable to protect fasteners holding the hinge assembly to a mounting surface such as an access door. The hinge assembly may be incorporated into a bar lock assembly to provide additional tamper resistance for a shipping container, for example, to limit or prevent unauthorized access to the container.

### CROSS REFERENCE TO RELATED APPLICATION

The present application claims the benefit of U.S. provisional application Ser. No. 61/046,997, filed Apr. 22, 2008, which is hereby incorporated herein by reference in its entirety.

### FIELD OF THE INVENTION

The present invention relates generally to hinges and, more particularly, to hinges used on container doors and the like.

### BACKGROUND OF THE INVENTION

Access doors for containers, such as shipping containers, semitrailers, and the like, are typically hinged at one side and secured via a bar lock. The bar lock is typically pivotally mounted opposite the door hinges and is positionable between an open or unlocked position, and a closed or locked position. In the locked position, the bar lock is typically held in position by a shackle, a seal, a padlock, or the like. However, the hinges to which the bar lock is pivotally mounted may have fasteners, such as screws or bolts, that are readily accessible and/or removable, such that the bar lock may be defeated by removing the hinges rather than tampering with the shackle, seal, or padlock.

### SUMMARY OF THE INVENTION

The present invention provides an anti-tamper member or plate that is fixedly attached to a hinge, such as the hinge of a bar lock system, in order to prevent access to the fasteners of the hinge when the bar lock is in a closed or locked position. The anti-tamper member substantially covers the fasteners of the hinge in order to discourage or prevent access to the hinge fasteners, thus improving the security of the bar lock.

According to one form of the present invention, the tamper resistant hinge includes a hinge plate, at least one fastener, and an anti-tamper member. The fasteners couple the hinge plate to a mounting surface, such as a door or a wall. The anti-tamper member substantially covers and protects the fasteners in order to inhibit access to the fasteners, thereby limiting or substantially preventing removal of the fasteners and the hinge.

According to another form of the present invention, a tamper resistant hinge, such as for a bar lock assembly on a shipping container or trailer, includes a hinge plate, at least one fastener, a hinge pin, a pivot arm, and an anti-tamper member. The hinge plate defines or forms a passageway for receiving the hinge pin, to which the pivot arm is pivotally coupled. The fasteners, which may be screws, bolts, rivets, or the like, couple the hinge plate to a mounting surface such as a door, a panel, or a wall. The pivot arm defines a passageway for receiving the hinge pin and is pivotally coupled to the hinge plate via the hinge pin so that the pivot arm can pivot between an open position and a closed position. The anti-tamper member is fixed to the pivot arm so that the anti-tamper member substantially covers the fasteners when the pivot arm is in the closed position. The anti-tamper plate exposes the fasteners when the pivot arm is moved to the open position.

In one aspect, the anti-tamper member is a substantially rectangular plate, which may have rounded corners or ends. Optionally, the anti-tamper member may have opposite end portions located at opposite ends of a planar main body portion, the opposite end portions being angled with respect to the main body portion. The angled end portions closely cover the fasteners when the pivot arm is moved to the closed position to prevent prying of the anti-tamper member and to further reduce access to the fasteners.

Therefore, the present invention provides a device that limits or prevents access to the fasteners of a hinge in order to prevent or resist tampering with the fasteners and removal of the hinge. Thus, a locked door or a locked bar lock assembly may be provided with additional security by protecting the hinges from tampering or removal.

These and other objects, advantages, purposes, and features of the present invention will become apparent upon review of the following description in conjunction with the drawings.

### BRIEF DESCRIPTION OF THE DRAWINGS

FIG. 1 is a front elevation of a bar lock system including a pair of tamper resistant hinges in accordance with the present invention;

FIG. 2 is a side elevation of an anti-tamper member;

FIG. 3 is an end sectional view of a hinge assembly, taken along the section designated III in FIG. 1;

FIG. 4 is a top perspective view of a hinge assembly in accordance with the present invention;

FIG. 5 is a rear view of the hinge assembly of FIG. 4, in an open position; and

FIG. 6 is a front view of the hinge assembly of FIG. 4, in a closed position.

### DESCRIPTION OF THE PREFERRED EMBODIMENTS

Referring now to the drawings and the illustrative embodiments depicted therein, a tamper resistant system 10 includes a bar lock assembly 11 and a pair of tamper resistant hinge assemblies 12 for securing an access door, such as a trailer or container door or the like. As will be more fully described below, each hinge assembly 12 substantially limits or prevents access to fasteners that hold bar lock assembly 11 to the access door or other mounting surface.

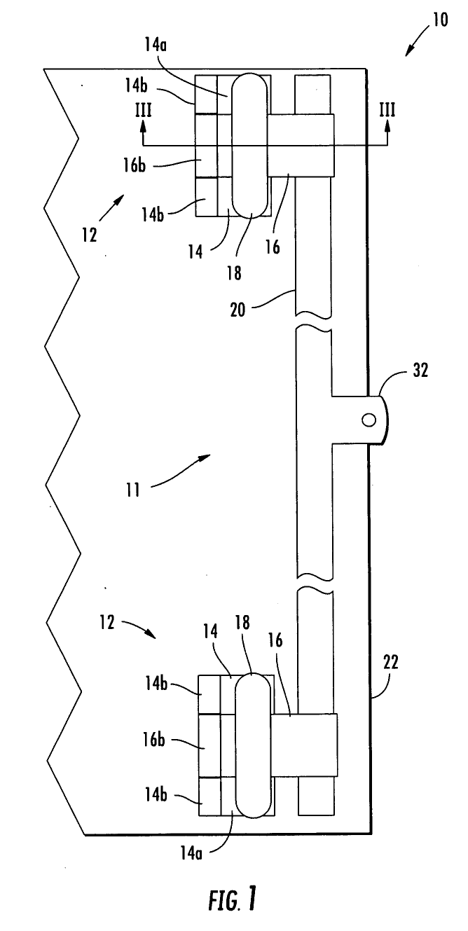

Hinge assembly 12 includes a hinge plate 14, a pivot member 16, and an anti-tamper member 18 (FIGS. 1 and 3-6). Hinge assemblies 12 are coupled together by a lock bar 20 that spans between hinge assemblies 12, which are connected to a mounting surface such as a door 22. Pivot member 16 is pivotally connected to hinge assembly 12 so that lock bar 20 may be moved or pivoted relative to hinge plate 14 and the mounting surface 22.

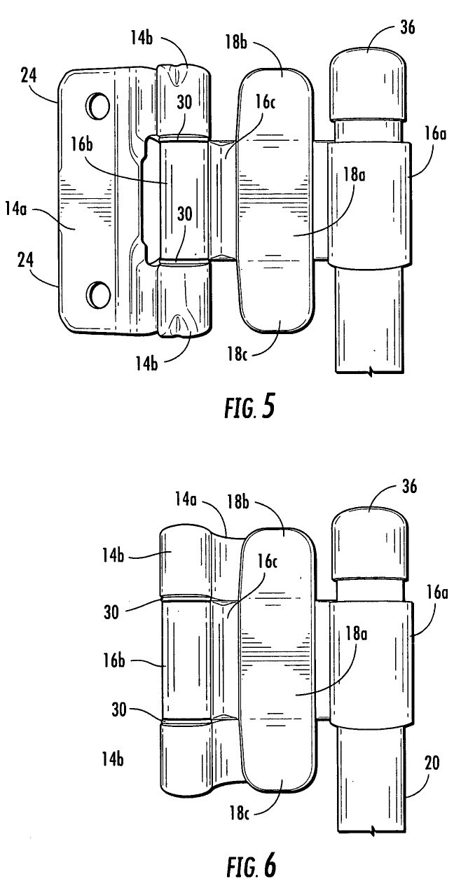

Hinge plate 14 includes a generally planar portion 14a that is positioned at or near door 22 (FIGS. 1 and 3). Planar portion 14a includes a pair of holes or passageways 24 (FIG. 5) for receiving fasteners 26 therethrough (FIG. 3). A pair of tangs 14b project from planar portion 14a of hinge plate 14 and are curved to form substantially circular passageways for receiving a hinge pin 28. Hinge plate 14 is mounted to mounting surface 22 via fasteners 26. Fasteners 26 may be threaded screws, bolts, rivets, or the like, and may be fastened to mounting surface 22 with a receiving member 34, such as a threaded nut.

Pivot member 16 includes a curved lock bar engaging portion 16a, a substantially round or circular hinge pin engaging portion 16b, and a substantially flat planar portion 16c located between and connecting the bar engaging portion 16a and the hinge pin engaging portion 16b. Bar engaging portion 16a has a radius of curvature substantially conforming to that of lock bar 20, and may be fixed to the lock bar 20, such as by welding or with fasteners. Hinge pin engaging portion 16b is positioned between hinge plate tangs 14b so that the passageway defined by hinge pin engaging portion 16b is aligned and substantially coaxial with the passageways defined by tangs 14b. Optionally, lock bar 20 may be rotatably mounted to pivot member 16, as may be desirable in certain applications, without departing from the spirit and scope of the present invention.

Hinge pin 28 is installed in passageways of hinge plate tangs 14b and hinge pin engaging portion 16b of pivot member 16 so that pivot member 16 is pivotally mounted or coupled to hinge plate 14. As shown in FIGS. 4 and 5, hinge plate tangs 14b may be crimped at their outer portions to preclude or substantially prevent the unauthorized removal of hinge pin 28. Bushings 30 (FIGS. 5 and 6) may be positioned on either side of hinge pin engaging portion 16b and around hinge pin 28 to prevent undue wear, binding, noise, and unauthorized access to hinge pin 28 through gaps between hinge pin engaging portion 16b and hinge plate tangs 14b. When pivot member 16 is at a closed position (FIGS. 3, 4, and 6), planar portion 16c is adjacent and substantially parallel to hinge plate planar portion 14a. When pivot member 16 is moved to an open position (FIG. 5), bar engaging portion 16a and planar portion 16c extend outwardly away from hinge plate tangs 14b and generally away from planar portion 14a of hinge plate 14.

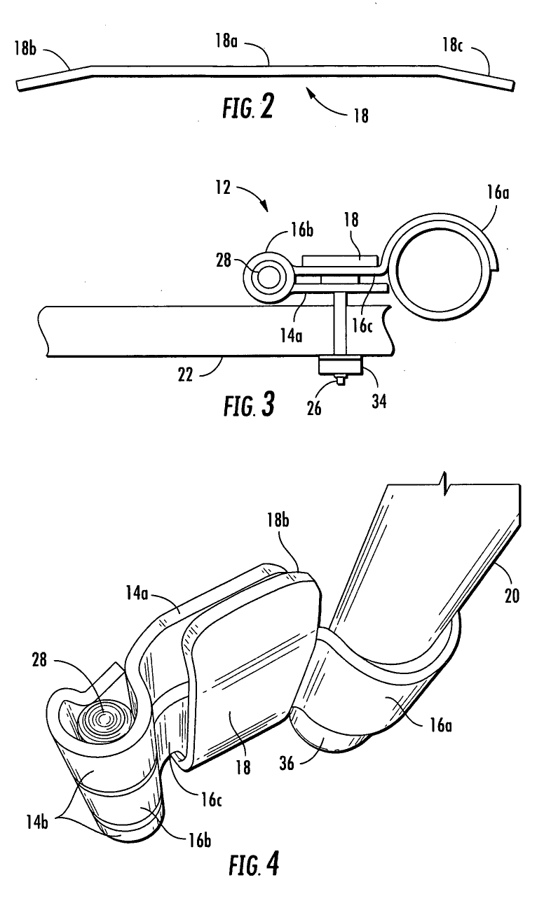

Anti-tamper member 18 is coupled to planar portion 16c of pivot member 16 and pivots with pivot member 16 relative to hinge plate 14. Anti-tamper member 18 has a generally planar main body portion 18a and opposite end portions 18b, 18c extending outwardly from main body portion 18a (FIG. 2). Anti-tamper member 18 is coupled to pivot member 16 at main body portion 18a, which may be welded or fastened to planar portion 16c of pivot member 16. End portions 18b, 18c of anti-tamper member 18 thus extend outwardly beyond planar portion 16c of pivot member 16 and substantially cover and guard fasteners 26 and portions of hinge plate planar portion 14a when pivot member 16 is in the closed position (FIGS. 4 and 6). When pivot member 16 is in the open position (FIG. 5), anti-tamper member 18 is positioned away from hinge plate 14, thus permitting access to hinge plate 14 and fasteners 26.

Optionally, anti-tamper member end portions 18b, 18c are angled relative to main body portion 18a to reduce the size of any gap that may exist between anti-tamper member 18 and hinge plate planar portion 14a when pivot member 16 is in the closed position (FIG. 4). For example, anti-tamper member end portions 18b, 18c may be angled at about fifteen degrees in order to reduce access to fasteners 26. Thus, anti-tamper member 18 limits or substantially precludes the use of a pry bar or other tool to access fasteners 26 when pivot member 16 is in the closed position. Anti-tamper member 18 is generally rectangular in shape, and may have rounded corners and/or rounded ends to improve the aesthetics and safety of hinge assembly 12. Optionally, anti-tamper member 18 may be incorporated into pivot member 16 or unitarily formed therewith, without departing from the spirit and scope of the present invention. For example, the pivot member may be stamped or formed from sheet metal with wings or projections similar to end portions 18b, 18c of anti-tamper member 18, with the main body portion 18a replaced by the pivot member itself.

Pivot member 16 is selectively held in the closed position by lock bar 20, which includes a locking portion 32 that is engaged by a seal (such as a strap-type seal), a latch, a shackle, a lock (such as a padlock), or the like. Pivot member 16 is thus positionable relative to hinge plate 14 by grasping lock bar 20 and pushing or pulling the lock bar to reposition pivot member 16. When pivot member 16 and lock bar 20 are in their closed position, lock bar 20 may be locked or latched at locking portion 32, thereby preventing further movement of lock bar 20 and pivot member 16 and positioning anti-tamper member 18 to prevent access to fasteners 26. Optionally, end caps 36 may be provided at lock bar 20 to limit or prevent entry of water and debris into lock bar 20, which may be a hollow tubular member, for example.

Hinge assembly 12 is made from any suitably strong, tamper-resistant material, such as high strength steel, stainless steel, high strength aluminum alloy, or the like. Preferably, anti-tamper member 18 is made of sufficiently strong material, such as high strength steel, in order to resist flexing or grinding.

Changes and modifications to the specifically described embodiments may be carried out without departing from the principles of the present invention, which is intended to be limited only by the scope of the appended claims, as interpreted according to the principles of patent law including the doctrine of equivalents.

The embodiments of the invention in which an exclusive property is claimed are defined as follows:

1. A tamper-resistant hinge comprising:
a hinge plate;
a pivot member pivotally coupled to said hinge plate;
at least one fastener at said hinge plate, said fastener coupling said hinge plate to a mounting surface;
an anti-tamper member extending outwardly from said pivot member, said anti-tamper member substantially covering and protecting said at least one fastener at said hinge plate in order to substantially inhibit access to said fastener.

2. The tamper-resistant hinge of claim 1, wherein said at least one fastener comprises at least two spaced fasteners, and wherein said anti-tamper member is adapted to substantially cover and protect both of said at least two spaced fasteners.

3. The tamper-resistant hinge of claim 2, wherein said anti-tamper member comprises a substantially rectangular plate having rounded corners.

4. The tamper-resistant hinge of claim 2, wherein said anti-tamper member comprises:
a substantially rectangular planar main body portion; and
opposite end portions, each of said opposite end portions located at an opposite end of said main body portion and angled with respect to said main body portion.

5. The tamper-resistant hinge of claim 4, wherein each of said opposite end portions is angled at approximately 15 degrees relative to said main body portion.

6. The tamper-resistant hinge of claim 1, wherein said anti-tamper member is selectively positionable to substantially cover and protect said at least one fastener and to permit access to said at least one fastener.

7. A tamper-resistant hinge for a bar lock assembly, said hinge comprising:
a hinge plate, said hinge plate defining a passageway;
at least one fastener at said hinge plate, said fastener coupling said hinge plate to a mounting surface;
a hinge pin disposed in said passageway of said hinge plate;
a pivot arm, said pivot arm defining a passageway substantially coaxial with said passageway of said hinge plate and receiving said hinge pin, said pivot arm being pivotally coupled to said hinge plate via said hinge pin and pivotable between an open position and a closed position; and
an anti-tamper member fixedly coupled at said pivot arm, wherein said anti-tamper member substantially covers and protects said at least one fastener when said pivot arm is in said closed position, and wherein said anti-tamper member is configured to expose said at least one fastener when said pivot aim is in said open position.

8. The tamper-resistant hinge of claim 7, wherein said at least one fastener comprises a first fastener spaced from said pivot aim at one side, and a second fastener spaced from said pivot arm at a second side opposite said first side, wherein said anti-tamper member is adapted to substantially cover and protect said first fastener and said second fastener when said pivot arm is in said closed position.

9. The tamper-resistant hinge of claim 8, wherein said anti-tamper member comprises a substantially rectangular plate having rounded corners.

10. The tamper-resistant hinge of claim 7, wherein said anti-tamper member comprises:
a substantially rectangular planar main body portion; and
opposite end portions, each of said opposite end portions located at an opposite end of said main body portion and angled with respect to said main body portion.

11. The tamper-resistant hinge of claim 10, wherein each of said opposite end portions is angled at approximately 15 degrees relative to said main body portion.

12. A tamper-resistant system for a container, said system comprising:
a mounting surface;
a hinge assembly comprising a hinge plate, a fastener, and an anti-tamper member, wherein said fastener couples said hinge plate to said mounting surface and said anti-tamper member substantially covers and protects said fastener in order to substantially inhibit access to said fastener; and
a bar lock coupled to said hinge assembly, said bar lock being pivotable relative to said mounting surface between an open position and a closed position, wherein said bar lock is lockable in said closed position to preclude access to the container.

13. The tamper-resistant system of claim 12, wherein said anti-tamper member substantially covers and protects said fastener when said bar lock is in said closed position, and wherein said anti-tamper member is configured to expose said fastener when said pivot arm is in said open position.

14. The tamper-resistant system of claim 12, wherein said anti-tamper member comprises:
a substantially rectangular planar main body portion; and
opposite end portions, each of said opposite end portions located at an opposite end of said main body portion and angled with respect to said main body portion.

15. The tamper-resistant system of claim 14, wherein each of said opposite end portions is angled at approximately 15 degrees relative to said main body portion.

16. The tamper-resistant system of claim 12, wherein said system comprises a pair of said hinge assemblies and at least two fasteners at each of said hinge assemblies, said bar lock coupling said hinge assemblies to one another.
